(19) United States
(12) Patent Application Publication
(10) Pub. No.: US 2009/0006396 A1
(43) Pub. Date: Jan. 1, 2009

(54) CONTEXTUAL SEARCH

(75) Inventors: Bret Dunlap, Villanova, PA (US); David Sawyer, Dripping Springs, TX (US); Leonard John Cooper, Cape Town (ZA)

Correspondence Address: DUANE MORRIS LLP - Philadelphia;IP DEPARTMENT, 30 SOUTH 17TH STREET, PHILADELPHIA, PA, 19103-4196, US

(73) Assignee: ADVANCED MOBILE SOLUTIONS WORLDWIDE, INC., WAYNE, PA (US)

(21) Appl. No.: 12/132,421

(22) Filed: Jun. 3, 2008

Related U.S. Application Data
(60) Provisional application No. 60/941,804, filed on Jun. 4, 2007.

(51) Int. Cl. G06F 7/06; G06F 17/30

(52) U.S. Cl. 707/6; 707/E17.014

(57) ABSTRACT

A method of mobile communication advertising, having steps of entering one of a primary function keyword and a vanity keyword to a mobile communication device, entering a search term in a form of a message string into a data processing module, creating a list of category aliases, creating a list of category names, comparing the list of category aliases to the message string for a length, a category alias and a category name, identifying matches between the category aliases and the message string, wherein matches are placed into a search category list, removing matched category phrases from the search message to leave advertising search words, determining a search sub-module based upon the advertising search words, conducting a search using the sub-module; and sending a search result obtained from the sub-module to a mobile communication device, receiving the search result from the sub-module to a mobile communication device, and displaying the search result on the mobile communication device.

### CROSS-REFERENCE TO RELATED APPLICATIONS

This non-provisional application claims priority to U.S. Provisional Patent Application Ser. No. 60/941,804, dated Jun. 4, 2007, the entirety of which is incorporated herein by reference.

### FIELD OF THE INVENTION

Aspects of the invention relate to an automated method for searching advertisements. More specifically, aspects of the invention relate to searching classified advertisements using SMS text message commands and search criteria through a mobile device and existing mobile carrier networks.

### BACKGROUND INFORMATION

Classified advertisements are an important tool for commercial and private interests that need to obtain or sell goods and services. Print media, for example, has long dominated classified advertising to the extent that the sale of classified advertising has become a key profit center for newspaper economics.

The rise of the Internet and computer interconnectivity has provided new opportunities for selling goods and services in addition to the long dominated classified advertising of print media. The print media, in response to the rise of Internet advertising, have decided to increase their selling opportunities and offer both traditional print advertising, as well as digital publication of advertising. This strategy can offer advertisers two distribution channels and command more revenue per advertisement.

Conventionally, some internet portals, however, offer free advertising models for advertisers. As a result, newspapers are looking to offer greater value to their classified customers in order to keep generating profits from the advertising.

Internet connectivity has developed from a stationary connection capability to a mobile connection capability. The media has recognized that mobile systems have developed an access standard allowing a similar environment as the World Wide Web. The mobile web offers a portable digital channel and allows the media to capitalize on its digital content. Classified ads are one of the most prevalent ways to monetize the mobile opportunity.

### SUMMARY

In one aspect, a method of mobile communication advertising is presented. The method entails steps of entering one of a primary function keyword and a vanity keyword to a mobile communication device and entering a search term in a form of a message string into a data processing module. The method then entails the steps of creating a list of category aliases, creating a list of category names, comparing the list of category aliases to the message string for a length, a category alias and a category name, identifying matches between the category aliases and the message string, wherein matches are placed into a search category list and removing matched category phrases from the search message to leave advertising search words. The method then entails determining a search sub-module based upon the advertising search words, conducting a search using the sub-module, and sending a search result obtained from the sub-module to a mobile communication device. The method then entails the steps of receiving the search result from the sub-module to a mobile communication device and displaying the search result on the mobile communication device.

In another aspect, the method above may be accomplished such that the search is for an automobile specific product.

In another aspect, the method may be accomplished such that the conducting the search using the sub-module further comprises comparing the search string to the vanity keyword, wherein a match between the vanity keyword and the search string, the search is limited to advertisements by an advertiser associated with the vanity keyword. Non-matching terms between the vanity keyword and the search string are compared to a database. The method then entails the steps of selecting category tree results for terms matching between the search string and the database, obtaining un-matched words between the search string and the database and matching them against an advertising body.

In another aspect, the method may be accomplished such that the search is for a merchandised product.

In another aspect, the method may further comprise assigning a unique incremental identification number for each search result.

In another aspect, a program storage device readable by machine, tangibly embodying a program of instructions executable by the machine to perform method steps of producing mobile communication advertising is provided. The method accomplished by the program storage device comprises entering one of a primary function keyword and a vanity keyword to a mobile communication device and entering a search term in a form of a message string into a data processing module. The program storage device also provides for creating a list of category aliases, creating a list of category names and comparing the list of category aliases to the message string for a length, a category alias and a category name. The program storage device also provides for identifying matches between the category aliases and the message string, wherein matches are placed into a search category list and removing matched category phrases from the search message to leave advertising search words determining a search sub-module based upon the advertising search words. The method accomplished by the program storage device also provides for steps of conducting a search using the sub-module, sending a search result obtained from the sub-module to a mobile communication device, receiving the search result from the sub-module to a mobile communication device, and displaying the search result on the mobile communication device.

In another aspect, the program storage device described above can be performed such that the search is for an automobile specific product.

The program storage device may also be configured wherein the conducting the search using the sub-module further comprises comparing the search string to the vanity keyword, wherein a match between the vanity keyword and the search string, the search is limited to advertisements by an advertiser associated with the vanity keyword and non-matching terms between the vanity keyword and the search string are compared to a database. The program storage device may also be configured such that the method accomplished may include selecting category tree results for terms matching between the search string and the database and obtaining un-matched words between the search string and the database and matching them against an advertising body.

The program storage device may also be configured such that the program storage device accomplishes the method wherein the search is for a merchandised product.

The program storage device may also be configured such that the method accomplished provides for assigning a unique incremental identification number for each search result.

### BRIEF DESCRIPTION OF THE DRAWINGS

FIG. 1 is a conceptual overview of the contextual search embodiment as illustrated and described.

FIG. 2 is a logical message flow diagram of the contextual search embodiment of FIG. 1.

FIG. 3 is a logical search process diagram.

FIG. 4 is a method of a contextual search, according to one aspect embodiment.

### DETAILED DESCRIPTION

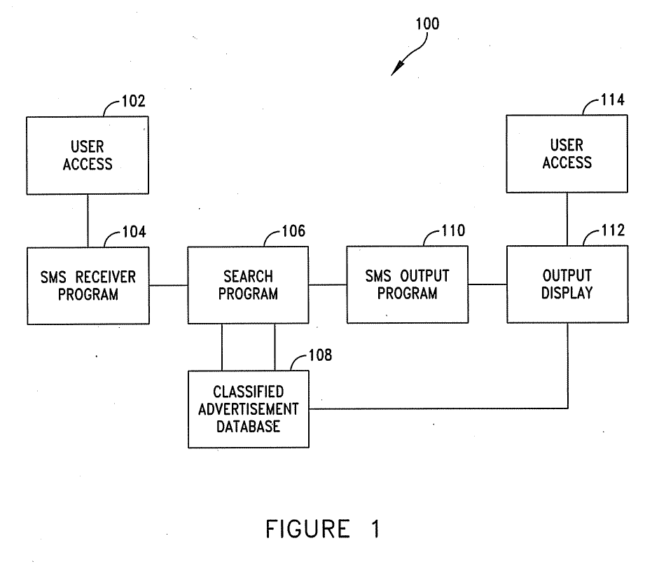

Referring to FIG. 1, an overview 100 of a contextual search method embodiment is illustrated. The overview 100 provides for user access 102 to a system for processing requests, such as, for example, one that processes internet search requests. The contextual search method may be used to provide information, such as data, to individuals who are connected to a mobile network. The data, for example, can be related to results obtained from searching a real estate database for houses that fit defined data requirements. The data may also be related to other types of advertising databases, such as, for selling automobiles. A SMS receiver program 104 is configured such that the user may access the program 104 to send and receive messages through a mobile device, such as a mobile phone or PDA, as non-limiting examples. The SMS receiver program 104 is configured to interface with a search program 106, for example to send and receive information between the SMS receiver program 104 and the search program 106. The search program 106, in the illustrated embodiment, is located on a computer server and is addressable by the SMS receiver program 104, through programming. The search program 106 allows for queries to be received and processed through search programming and techniques provided therein. The search program 106 interfaces with a classified advertisement database 108. The search program 106 attempts to match the search inquiry provided by the user to information contained in the classified advertisement database 108. The database 108 may be a single database, or multiple databases, as necessary. The database 108 may contain information from various sources, such as advertisements for cars or real estate, as non-limiting examples. The database 108 may be maintained and stored on a separate addressable computer server. Interconnection between the database 108 and the search program is optimized to provide results quickly to a user providing an inquiry. The search program 106 thereafter interfaces with a SMS output program 110 that accepts data from the search program 106 and the results, as derived from the classified advertisement database 108. The SMS output program 110 provides data to the mobile communication device, in this embodiment, a mobile communication device with an output display 112. A user may access 114 the output display 112 to retrieve the information, as necessary. The SMS output program 110 may interface with standard data transfer capabilities.

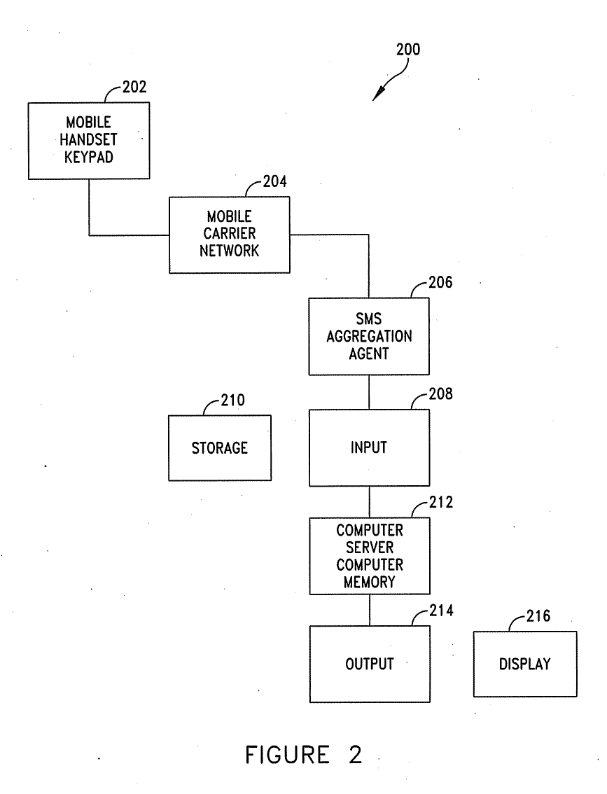

Referring to FIG. 2, a logical message flow diagram 200 of the contextual search embodiment is illustrated. A mobile handset keypad 202 for a mobile communication device is provided with a capability to interface with a mobile carrier network 204. The mobile carrier network 204 may be any such common mobile carrier network, as conventionally known. The mobile carrier network 204 is connected to a SMS aggregation agent 206 that accepts and processes SMS messages emanating from the mobile carrier network 204. The SMS Aggregation Agent 206 is connected to an input 208 of the computer server computer memory 212 such that information inputted into the computer server/computer memory 212 are evaluated. A storage unit 210 is configured to be addressed by the computer server/computer memory 212 such that contents of the storage unit 210 may be downloaded, as needed, for display. The computer server/computer memory 212 is connected to an output 214. The output 214 may be a computer carrier network 204 to provide signals to a mobile communication device. Communications from the output 214 may be displayed 216 on the mobile communication device.

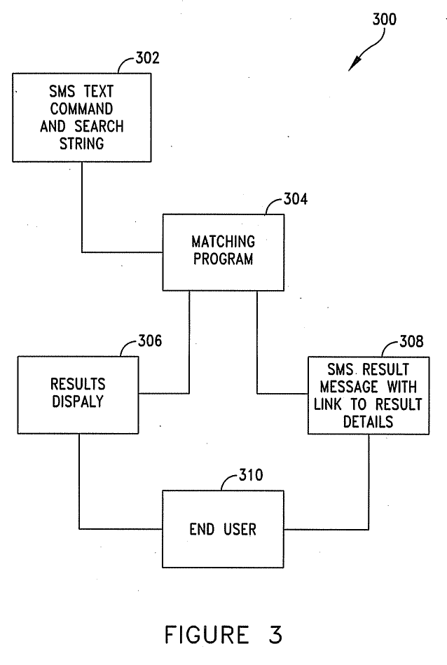

Referring to FIG. 3, a logical search diagram 300 for the contextual search is illustrated. The diagram 300 provides for a SMS Text Command and Search String 302 to be entered to a mobile communication device, for example. The mobile communication device interfaces with a matching program 304. The matching program 304 attempts to match the SMS Text Command and Search String 302 with defined categories provided in a database. The matching program 304 interfaces, in turn, with a results display 306 and a SMS result message with a dynamically generated URL link to result details 308. The matching program 304 after matching the Text Command and Search string to the data obtained from, for example, an attached database, may download the information to an end user 310 that reads the results from a results display 306.

In an alterative path of the logical search diagram 300, the matching program 304 produces a SMS Result message with a link to result details 308. The end user 310 interfaces with the SMS Result message for retention of the information.

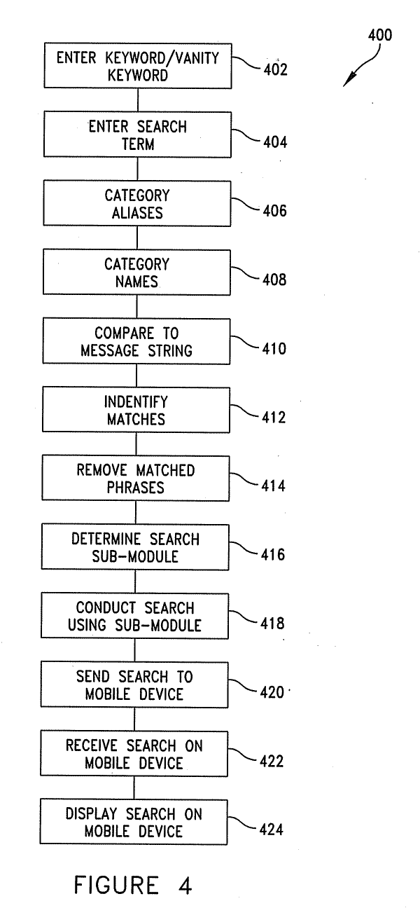

Referring to FIG. 4, a method 400 of mobile communication advertising is presented. First, the method entails entering one of a primary function keyword and a vanity keyword to a mobile communication device 402. Next the user enters a search term in a form of a message string into a data processing module 404. Next, a list of category aliases is created 406. Next, a list of category names is created 408. The list of category aliases is compared to the message string for a length, a category alias and a category name 410. Matches are identified between the category aliases and the message string, wherein matches are placed into a search category list 412. Matched category phrases are removed from the search message to leave advertising search words 414. A search sub-module is determined based upon the advertising search words 416. A search is then conducted using the sub-module 418. A search result obtained from the sub-module is then sent to a mobile communication device 420. The search result from the sub-module is received to a mobile communication device 422. The search result is then displayed on the mobile communication device 424.

### General Structure of a Text Search String

The general text message structure is as follows:

Primary_Function_Keyword Category Subcategory(s) Filter(s)

As an example, if a searcher is interested in a house in Houston, Tex. with the requirement that it must have a pool and a fireplace, the search would be performed as below:

### Exemplary Embodiment

1. A mobile Handset user sends a text message to a short code:
Search homes Houston pool fireplace

2. Return SMS message containing dynamically generated URL link is sent back to Mobile Handset User:
Follow link to view 46 matches
http://mobile.chron.com/srch.php?srchid=4085. If unable to link, go to phone's browser & enter mobile.chron.com to search.

3. Mobile Handset User accesses the URL and List page is created.
Search/WEB ID/MSL#
Click to Search
Page 1 of 15
next>last>>
North Houston
HURRY!! JUST ½ BLOCK FROM POOL AND PARK; SELLER HAS ASKED FOR COSMETIC REPAIR BIDS; NICE 3 BEDROOM HOME FOR FIRST TIME BUYER, COUPLE OF SINGLE PARENT; OPEN & BRIGHT, LARGE LIVING AREA WITH MIRRORED . . .
Price $99,000
More Details
North Houston
PLS. CONTINUE TO SHOW THIS HOME, CURRENT BUYER FINANCING DOESN'T LOOK GOOD! SUBMIT OFFERS NOW! NEW/NEVER USED BEFORE STAINLESS STEEL SIDE BY SIDE REFIDGE, RANGE & DISHWASHER, WASHER & DRYER, WOOD . . .
Price $99,000
More Details
North Houston
Had multiple offers seller is negotiating, please do not send anymore of offers until further notice!! Corporate owned 3/2/2 lovely one story in quiet neighborhood close to area park and pool/High . . .
Price $74,900
More Details
Energy Corridor
NATURE AT IT'S BEST. GORGEOUS SETTING IN HEATHWOOD. WOODED WITH POOL. GREAT ROOM WITH HIGH CEILINGS, FIREPLACE AND WET BAR, BRIGHT KITCHEN AND BREAKFAST, MASTER DOWN WITH FIREPLACE, STUDY OFF MASTER.
Price $569,900
More Details
Energy Corridor
Casual elegance defines this Laguna Springs traditional. The home's flow and balance make it ideal for entertaining while providing privacy for family and guests. Patio/pool area can be seen from the . . .
More Details
next>last>>

4. Mobile Handset user selects a particular advertisement, or navigates to the next list page. Details page:
Search/WEB ID/MSL#
Click to Search
Back
Single Family
Details
Type: Single Family
Bedrooms: 3
Full Bath: 2
MLS 3774290
Zip: 77088
Style: TRADITIONAL
Price: $99,500
Click for Photos
Call Agent
Email this listing
Advertising Sponsorships Available.
DESCRIPTION
HURRY!! JUST ½ BLOCK FROM POOL AND PARK; SELLER HAS ASKED FOR COSMETIC REPAIR BIDS; NICE 3 BEDROOM HOME FOR FIRST TIME BUYER, COUPLE OF SINGLE PARENT; OPEN & BRIGHT, LARGE LIVING AREA WITH MIRRORED WALL AND SUNKEN CONVERSATION AREA AT FRONT OF COZY WOOD BURNING FIREPLACE; PRIVATE SITTING AREA OR STUDY OFF MASTER BEDROOM. THIS MAY BE THE ONE!!!

After the mobile user has constructed his text message, or before depending on the handset manufacturer, model and mobile carrier, a text message is sent to a common short code. The common short code is selected by the newspaper customer upon system installation. Upon receipt of the text search string, the search method of the mobile classified system is initiated.
General Method
Primary function keyword or Vanity keyword determined (Search, view, etc.) and appropriate processing module initiated. In case of Vanity keywords, search is assumed and vanity keyword flags are set.
List of category aliases and category names is built.
Category list is compared to message string, in order of length (longest category alias/name to shortest) by category alias and then by category name. Matches are tracked by grandparent, parent, child tree (category, subcat, subcat, subcat) as per the order they appear in the message string. This means that if a category is matched, its children (subcategories) are searched for matching category names. Matches are determined and placed into search category list. This is the list of categories in which a matching advertisement must appear.
Matched category “phrases” removed from the search message to leave the advertising search words.
Based on the category tree as found in 3 above, the search sub modules is determined (Real Estate, Autos, Merchandise, etc.). Search sub-modules are specifically tailored methods, based on the general method to accommodate specific data requirements. For instance, automobile data contain make and model information which is not found in the Real Estate category. Each step in the following modules is used to narrow the possible result set for category-specific requirements.
Automobile Specific
Vanity keywords are compared to a search string. If a match is found, the search is limited to advertisement by the advertiser indicated by the vanity keyword.
All remaining words are matched against the database for make, model and year (if a numeric string), with the predetermined category/category tree (parent-child-child). Matching words eliminated from the search message.
Remaining un-matched words (not Vanity keyword, category, make, model, year) are matched against the advertisement body.
Real Estate Specific
the category tree structure of the Real Estate contains multiple entries of the same name, as the sub-structure indicates geographic areas. Thus, the same area may exist as a child of many parents. This information is taken into account during the search process and the search needs to allow for multiple points within the real-estate tree for any given search.
Vanity keywords are then compared to the search string. If a match is found, the search is limited to advertisements by the advertiser indicated by the vanity keyword.
Words are checked for a probability of being a zipcode. The information is matched against zipcodes that are available in the current advertisement set. If a match is made, the search is limited to those zipcodes.
The remaining words are compared to the Advertisement data.
Words are then compared to the area of information of advertisements, the property type of advertisements and zipcode of advertisements. Matching words are eliminated, and the result set is limited to matching advertisements.
The remaining search words are matched against the advertisement body (the description).
Merchandise
A. Non-category filter words are matched against the advertisement body.

Search Results Processing

Each search is assigned a unique incremental identification number and is associated with a unique result set that is stored in a table and assigned a unique URL. The Mobile Classified System constructs and sends a return SMS message that includes the total results in the search, static summary text, and the unique URL. As the mobile handset user navigates the URL, pages are generated and dynamically published to display the results according to a set of formatting rules.

What is claimed is:

1. A method of mobile communication advertising, comprising:
entering one of a primary function keyword and a vanity keyword to a mobile communication device;
entering a search term in a form of a message string into a data processing module;
creating a list of category aliases;
creating a list of category names;
comparing the list of category aliases to the message string for a length, a category alias and a category name;
identifying matches between the category aliases and the message string, wherein matches are placed into a search category list;
removing matched category phrases from the search message to leave advertising search words;
determining a search sub-module based upon the advertising search words;
conducting a search using the sub-module;
sending a search result obtained from the sub-module to a mobile communication device;
receiving the search result from the sub-module to a mobile communication device; and
displaying the search result on the mobile communication device.

2. The method according to claim 1, wherein the search is for an automobile specific product.

3. The method according to claim 2, wherein the conducting the search using the sub-module further comprises:
comparing the search string to the vanity keyword, wherein a match between the vanity keyword and the search string, the search is limited to advertisements by an advertiser associated with the vanity keyword;
non-matching terms between the vanity keyword and the search string are compared to a database;
selecting category tree results for terms matching between the search string and the database;
obtaining un-matched words between the search string and the database and matching them against an advertising body.

4. The method according to claim 1, wherein the search is for a merchandised product.

5. The method according to claim 1, further comprising:
assigning a unique incremental identification number for each search result.

6. A program storage device readable by machine, tangibly embodying a program of instructions executable by the machine to perform method steps of producing mobile communication advertising, comprising:
entering one of a primary function keyword and a vanity keyword to a mobile communication device;
entering a search term in a form of a message string into a data processing module;
creating a list of category aliases;
creating a list of category names;
comparing the list of category aliases to the message string for a length, a category alias and a category name;
identifying matches between the category aliases and the message string, wherein matches are placed into a search category list;
removing matched category phrases from the search message to leave advertising search words;
determining a search sub-module based upon the advertising search words;
conducting a search using the sub-module;
sending a search result obtained from the sub-module to a mobile communication device;
receiving the search result from the sub-module to a mobile communication device; and
displaying the search result on the mobile communication device.

7. The program storage device according to claim 6, wherein the search is for an automobile specific product.

8. The program storage device according to claim 7, wherein the conducting the search using the sub-module further comprises:
comparing the search string to the vanity keyword, wherein a match between the vanity keyword and the search string, the search is limited to advertisements by an advertiser associated with the vanity keyword;
non-matching terms between the vanity keyword and the search string are compared to a database;
selecting category tree results for terms matching between the search string and the database;
obtaining un-matched words between the search string and the database and matching them against an advertising body.

9. The program storage device according to claim 6, wherein the search is for a merchandised product.

10. The program storage device according to claim 6, further comprising:
assigning a unique incremental identification number for each search result.
